(19) United States
(12) Patent Application Publication
(10) Pub. No.: US 2014/0255548 A1
(43) Pub. Date: Sep. 11, 2014

(54) LOW-FAT FERMENTED MILK EXCELLENT IN SAVOR AND PROCESS FOR PRODUCTION THEREOF

(71) Applicant: Meiji Co. Ltd., Tokyo (JP)

(72) Inventors: Hiroshi Horiuchi, Kanagawa (JP); Nobuko Inoue, Kanagawa (JP); Akira Yano, Kanagawa (JP)

(73) Assignee: Meiji Co. Ltd., Tokyo (JP)

(21) Appl. No.: 14/187,472

(22) Filed: Feb. 24, 2014

Related U.S. Application Data
(63) Continuation-in-part of application No. 12/525,405, filed on Jul. 31, 2009, now abandoned.
Application No. 12/525,405 is a continuation-in-part of application No. 12/226,258, filed on Sep. 9, 2009.

(30) Foreign Application Priority Data
Apr. 13, 2006 (JP) 2006-110605

(51) Int. Cl. A23C 9/123

(52) U.S. Cl. CPC A23C 9/1238
USPC 426/43; 426/34; 426/580

(57) ABSTRACT

The invention aims to provide a process for producing a fermented milk capable of effectively preventing deterioration of the smooth mouth feel and milk flavor originated from the milk fat (hereinafter, the smooth mouth feel and milk flavor are put together referred to as “milk-fat characteristic”) which are lost when the milk fat content of fermented milk is intentionally reduced, without using milk fat substitutes, milk-flavor providing agents or the like but based on an ingenuity on the production process, and the fermented milk obtained as the result in which the milk-fat characteristic is improved and the milk fat content is reduced.

The invention relates to a process for producing fermented milk in which a milk fat content is from 0.1% by weight to 2.0% by weight, said process comprising: reducing a dissolved oxygen concentration in a fermented milk mix to 5 ppm or less at the time of the start of fermentation; and carrying out the fermentation at a fermentation temperature of from 30□ C. to 39□ C., to thereby improve milk-fat characteristic, and the like.

### REFERENCE APPLICATIONS

### Cross-Reference to Related Applications

This application is a continuation-in-part of U.S. Ser. No. 12/525,405, filed Aug. 6, 2009, which is a national stage filing under 35 U.S.C. §371 of international application PCT/JP2007/052042, filed Feb. 6, 2007. This application is also a continuation-in-part of U.S. Ser. No. 12/226,258, filed Sep. 9, 2009, which is a national stage filing under 35 U.S.C. §371 of international application PCT/JP2007/058131, filed Apr. 13, 2007, which claims the benefit of a priority right based on Japanese Patent Application No. 2006-110605 filed Apr. 13, 2006. The disclosures of all of the above are hereby incorporated by reference in their entireties for all purposes.

### TECHNICAL FIELD

The present invention relates to fermented milk containing milk fat at a concentration lower than usual, and to a production process thereof.

Especially, the present invention relates to a process for producing fermented milk with reduced milk fat content, or fermented milk from which the milk fat content is reduced than usual, which can prevent deterioration of its flavor and mouth feel due to the reduction of the milk fat content without using an additive such as a substitute for milk fat and also can improve its flavor and mouth feel to a level higher than the products having milk fat content of usual concentration; and to a fermented milk obtainable by the process.

### BACKGROUND ART

Fermented milk is a commonly consumed food product and is well known to be a healthy food. However, from the viewpoint of healthy food, due to growing interest in diet, demand for low-calorie fermented milk containing less fat has been increasing because standard fermented milk contains approximately 3% by weight (hereinafter, the “by weight” is omitted) milk fat. Accordingly, a number of fermented-milk products advocating a low-fat feature have been provided in the market in recent years. However, because milk fat has a significant influence on good milk flavor and mouth feel provided by the fermented milk, it is necessary to compensate or improve such good milk flavor and mouth feel which are inevitably decreased by reducing the milk fat content in the fermented milk.

Most of the methods to achieve such improvement involve addition of low-calorie additives to replace milk fat, and agar and gelatin are mainly used as alternatives. These alternatives are used for providing “smooth mouth feel,” so that “mild mouth feel” including reduced sour taste that is artificially achieved by milk fat is a replacement. Therefore, these methods do not compensate for the deterioration of milk flavor, in particular the lack of “richness of taste (rich body),” which accompanies reduction of milk fat. Since this lack of “richness of taste (rich body)” has an especially great influence on the deterioration of milk flavor, there are many reports on milk-flavor providing agents which are added to the above mentioned agar and gelatin to enhance milk flavors (for example, patent documents 1 and 2).

However, all of these methods have been proposed based on the idea of making up for the milk fat content by certain substitutes. Thus, from the viewpoint of obtaining more natural deliciousness, concern has been directed toward the development of a method for controlling or improving deterioration of flavor and mouth feel without using the aforementioned milk fat substitutes, milk-flavor providing agents or the like when possible, or even when an additive is used inevitably, using it as little as possible.

In addition, new health-related functions of fermented milk have been widely publicized recently, including a dieting function and a function to reduce allergy such as hay fever. Regarding the dieting function, there is a report stating that this function is enhanced by taking commercially available fermented milk with addition of nonfat dry milk so as to increase its milk solids-not-fat (hereafter, referred to as SNF).

When fermented milk is made to have high SNF by adding nonfat dry milk, a decrease of flavor and mouth feel in the fermented milk is larger than that in fermented milk with a standard SNF content, and it is difficult to maintain its important feature of “deliciousness” as a food, while solving problems such as bad melt-in-mouth, rough mouth feel, and dry and crumbling mouth feel. In particular, when low-fat fermented milk is made to have high SNF by adding nonfat dry milk, its flavor tends to deteriorate further due to the inevitable decrease of good flavor derived from milk fat. Consequently, when manufacturing high-SNF fermented milk with good flavor and mouth feel, in particular high-SNF fermented milk with good flavor and mouth feel of a low-fat type, a method to effectively improve its flavor and mouth feel has been required.

Generally, to improve flavor and mouth feel of fermented milk, the use of additives such as flavors and polysaccharide thickeners has been widely adopted (for example, patent document 1). However, from the viewpoint of providing food products with more natural health-related functions, such a method wherein the flavor and mouth feel are improved by effects of the additives is not the best method; rather, development of a more natural method to solve the problems without using a technique to artificially improve the flavor by additives has been awaited.

Meanwhile, as a method to provide more delicate mouth feel for fermented milk, and to improve hardness of the fermented milk, the inventors of the present invention have clarified a production technique of novel fermented milk wherein fermentation is performed at a lower fermentation temperature of 30° C.-37° C. (patent document 3), and 38° C.-40° C. (patent document 4) while decreasing the dissolved oxygen concentration in a fermentation mixture to 5 ppm or less. However, a technique to improve flavor and mouth feel of low-fat fermented milk or high-SNF fermented milk using a natural method has not yet been known.
[Patent document 1] JP 2003-250482 A
[Patent document 2] JP PATENT No. 3706345
[Patent document 3] JP PATENT No. 3644505
[Patent document 4] JP PATENT No. 3666871

### DISCLOSURE OF THE INVENTION

### Problem to be Solved by the Invention

The invention has been made for the purpose of providing a process for producing a fermented milk capable of effectively preventing deterioration of the smooth mouth feel and milk flavor originated from the milk fat (the smooth mouth feel and milk flavor are put together referred to as “milk-fat characteristic” (a feeling of milk fat) hereinafter) which are lost when the milk fat content of fermented milk is intentionally reduced, without using milk fat substitutes, milk-flavor providing agents or the like but based on an ingenuity on the production process, and the fermented milk obtained as the result in which the milk-fat characteristic is improved and the milk fat content is reduced. In addition, the invention has been made for the purpose of providing fermented milk having milk-fat characteristic of at least equivalent to or greater than that of usual fermented milk, regarding fermented milk in which the milk fat content was intentionally reduced, particularly fermented milk having a milk fat content of 1% or more.

Further, the present invention also aims to solve the above problems, and to improve the decrease of milk flavor and mild mouth feel caused by reducing the milk fat content and increasing the SNF content by the addition of high concentration of nonfat dry milk, using a more natural method.

### Means of Solving the Problem

With the aim of solving the aforementioned problem, the inventors have conducted intensive studies and found as a result that a fermented milk having a clearly improved milk-fat characteristic in comparison with that of the fermented milk produced by an usual process and having low fat content can be obtained by carrying out the fermentation using a fermented milk mix in which the milk fat content was reduced from the usual concentration of about 3% to a level of from 0.1% to 2.0%, reducing dissolved oxygen concentration in the mix to 5 ppm or less, and lowering the fermentation temperature than usual and/or sharply decreasing the amount of the starter to be added to the mix from the usual additive amount.

Further, the present inventors devoted themselves to the research to solve the above problems, and found that, with respect to a fermented-milk mixture with reduced milk fat and a fermented-milk mixture with high SNF, by reducing the dissolved oxygen concentration in the mixture and by reducing the fermentation temperature to a temperature lower than usual, fermented milk with clearly improved milk-fat characteristic compared to fermented milk with less fat produced by a standard process can be obtained; and that in such a case, even when the amount of a starter added to the mixture is significantly reduced from a standard amount of addition, fermented milk with similarly improved milk-fat characteristic can be obtained by performing the fermentation at a fermentation temperature lower than usual. As a result of further research based on such findings, the inventors completed the present invention.

Namely, the present invention relates to follows:

[1] A process for producing fermented milk in which a milk fat content is from 0.1% by weight to 2.0% by weight, said process comprising:

reducing a dissolved oxygen concentration in a fermented milk mix to 5 ppm or less at the time of the start of fermentation; and

carrying out the fermentation at a fermentation temperature of from 30° C. to 39° C., to thereby improve milk-fat characteristic.

[2] A process for producing fermented milk in which a milk fat content is from 0.1% by weight to 2.0% by weight, said process comprising:

reducing a dissolved oxygen concentration in a fermented milk mix to 5 ppm or less at the time of the start of fermentation; and

setting an amount of a starter to be added to the fermented milk mix at from 25% to 50% of the amount thereof to be usually used and carrying out the fermentation at a fermentation temperature of from 38° C. to 46° C., to thereby improve milk-fat characteristic.

[3] A process for producing fermented milk in which a milk fat content is from 1.0% by weight to 2.0% by weight, said process comprising:

reducing a dissolved oxygen concentration in a fermented milk mix to 5 ppm or less at the time of the start of fermentation; and

carrying out the fermentation at a fermentation temperature of from 30° C. to 39° C., to thereby obtain a fermented milk having milk-fat characteristic equivalent to or greater than that of a fermented milk having an usual concentration of milk fat content, without using an additive which exerts an influence upon the milk-fat characteristic.

[4] A process for producing fermented milk in which a milk fat content is from 1.0% by weight to 2.0% by weight, said process comprising:

reducing a dissolved oxygen concentration in a fermented milk mix to 5 ppm or less at the time of the start of fermentation; and

setting an amount of a starter to be added to the fermented milk mix at from 25% to 50% of the amount thereof to be usually used and carrying out the fermentation at a fermentation temperature of from 38° C. to 46° C., to thereby obtain a fermented milk having milk-fat characteristic equivalent to or greater than that of a fermented milk having an usual concentration of milk fat content, without using an additive which exerts an influence upon the milk-fat characteristic.

[5] The process for producing fermented milk according to any one of [1] to [4], wherein the fermentation is carried out within such a period of time that the all fermentation steps are completed in one day.
[6] The process for producing fermented milk according to any one of [1] to [4], wherein the fermentation time is from 3 to 7 hours.
[7] A fermented milk which is obtainable by the process according to any one of [1] to [6].

Further, the present invention relates to follows:

[8] A process for producing fermented milk with a milk solids-not-fat (hereinafter, referred to as SNF) content of 11 wt % or more and/or a milk fat content of 0.1 wt %-2.0 wt %, wherein the dissolved oxygen concentration in a fermented-milk material mixture is controlled to 5 ppm or less at the start of the fermentation, and a starter is added to the fermented-milk material mixture and the fermentation is performed at 30° C.-46° C.
[9] The production process according to [8], wherein the fermentation temperature is between 30° C.-40° C.
[10] The production process according to [8], wherein the amount of the starter added to the fermented-milk material mixture is 50%-25% of the standard amount of addition.
[11] The production process according to [10], wherein the fermentation temperature is between 38° C.-46° C.
[12] A fermented milk with a SNF content of 11 wt % or more and/or a milk fat content of 0.1 wt %-2.0 wt % produced by the production process according to any one of [8]-[11].
[13] The fermented milk according to [12], characterized in that it has milk-fat characteristic with a level similar to that of fermented milk produced by a standard process having a milk fat content at least 1 wt % higher than that of the inventive fermented milk, without addition of a milk-fat alternative or a milk-flavor providing agent.

### Effects of the Invention

With respect to low-fat fermented milk having a low milk fat content from 0.1 wt % to 2.0 wt %, the invention has the effects of achieving milk-fat characteristic similar to that of fermented milk having a milk fat content at least 1 wt % higher than the above content prepared by a standard process, without addition of milk-fat alternatives or milk-flavor providing agents. For example, when low-fat fermented milks having a milk fat content of 0.1 wt %, 1.0 wt % and 2.0 wt % are produced by the production process of the invention, each of the fermented milks exhibits milk-fat characteristic with a level equivalent to or greater than that of fermented milks having a milk fat content of 1.1 wt %, 2.0 wt % and 3.0 wt % produced by the standard process, respectively. In particular, in cases of fermented milk having a milk fat content between 1.0 wt % and 1.5 wt % produced by the inventive process, the milk-fat characteristic with a level equivalent to or greater than that of standard fermented milk (3 wt %) can be obtained without addition of milk-fat alternatives or milk-flavor providing agents; thus, enhanced label of both “low fat” and “no additives used” can be adopted.

Furthermore, since problems occurring due to the addition of nonfat dry milk with an amount higher than usual to fermented milk in order to achieve high SNF, i.e., problems such as 1) bad melt-in-mouth, 2) rough mouth feel, and 3) dry and crumbling mouth feel can be solved by the invention, high-SNF fermented milk which can be a nutritious food having a good nutrient balance of high protein, low fat, high calcium and low calorie can be provided with improved flavor and mouth feel. In particular, with the high-SNF fermented milk having a SNF content of 11 wt % or more, the invention enables to improve flavor and mouth feel which are inevitably deteriorated with increasing SNF, without using additives such as flavor improving agents. Thus, according to the invention, delicious high-SNF fermented milk wherein the degree of deterioration in flavor and mouth feel is reduced even at high SNF contents can be provided.

Moreover, in the high-SNF low-fat fermented milk with a SNF content of 11 wt % or more and a milk fat content of 0.1 wt %-2.0 wt %, a decrease of flavor and mouth feel which accompanies increasing SNF as well as a decrease of flavor caused by less milk fat can be simultaneously improved. Thus, the invention enables to provide delicious high-SNF low-fat fermented milk wherein decreases of flavor and mouth feel caused by high SNF and low fat are improved even at high SNF and low fat contents.

### BEST MODE FOR CARRYING OUT THE INVENTION

Hereinafter, the present invention will be explained in detail.

Any milk may be used in accordance with the invention, with no specific limitation, so long as the milk is mammalian milk. Although the types thereof are not limited to the followings, they include cow milk, goat milk, sheep milk, water buffalo milk, swine milk and human milk. Among them, cow milk from Holstein species and Jersey species is preferably used owing to the ready availability and the cost.

Fermented milk in the present invention indicates “fermented milk” defined by the ministerial ordinance relating to ingredients of milk and milk products, which means a paste or liquid product obtained by fermenting milk, etc. using lactic acid bacteria or yeast, which contains a milk solids-not-fat content at a level equivalent to or higher than that of milk, or frozen products thereof. Fermented milk is broadly classified into two types. One is a pre-fermentation type, and the other is a post-fermentation type. The former is produced as follows: fermentation and cooling of the fermented milk is completed in a tank, then the fermented milk is crushed and filled into individual containers for distribution. The latter is produced as follows: a fermented-milk material mixture (hereinafter referred to as a mixture or a material mixture) is added with a predetermined amount of a starter, which is filled into individual containers for distribution such as paper containers, and then fermented in a fermentation chamber until lactic-acid acidity reaches a predetermined level so that it is solidified into a pudding-like state, followed by cooling. The pre-fermentation is commonly used for producing fruit yogurt with fruit flesh, drinking yogurt and the like, while the post-fermentation is commonly used for producing yogurt of so-called hard-type and plain-type, and the like.

With either fermentation type, a starter is added to a sterilized mixture at a predetermined temperature, and fermentation is carried out until the acidity reaches a predetermined level in the fermentation process, then the mixture is cooled to terminate the fermentation and obtain the final product. Since the fermentation temperature and fermentation time at this step not only affect the production efficiency of the product but also significantly affect the flavor and quality, it is necessary to set the fermentation temperature and fermentation time appropriately by taking those effects into account.

A material mixture of the invention can be obtained by heating and dissolving raw materials to be used regularly in the production of fermented milk, such as milk, nonfat milk, nonfat dry milk and other milk materials, sugar, saccharides, flavors, water and the like; when milk fat alternatives are used, gelatin solutions, agar solutions and pectin, etc., which have been preliminarily heated and dissolved, are added and mixed to the above mixture. However, in cases of the present invention and when the milk fat content is approximately 1.0 wt %-2.0 wt %, it is possible to provide products having rich milk-fat characteristic with a level similar to or greater than that of fermented milk having a standard milk fat content (approximately 3 wt %) produced by a standard process, without addition of milk fat alternatives; accordingly, a preferable embodiment of the invention is the one wherein gelatin, etc. is not added in the above milk fat content range. Therefore, in cases of the process according to the present invention, the addition of milk fat alternatives and others is practically considered only when “nonfat” products in which milk fat content is 0.5 wt % or less are to be produced.

A material mixture used in the invention does not contain peroxidase described in JP H10-99019 A as an additive.

Here, it is possible to control the milk fat content between 0.1 wt % and 2.0 wt % upon production of fermented milk of the invention, by changing the ratio of blending of raw milk and nonfat dry milk in a mixture. When nonfat dry milk alone which is generally available on the market is used without raw milk, and when SNF content is adjusted to the value of standard fermented milk by residual fat contained in said nonfat dry milk, the milk fat content becomes approximately 0.1 wt %

Thus-obtained material mixture with the adjusted milk fat content is homogenized, sterilized and cooled to a predetermined temperature (fermentation temperature). A process to reduce the dissolved oxygen concentration described later may be performed at this state; however, when the dissolved oxygen concentration is reduced by nitrogen replacement and others, this process of reducing the dissolved oxygen concentration may be omitted here. Next, the material mixture is inoculated with a lactic acid bacteria starter of a standard amount of addition or a smaller amount, and filled into a tank to start fermentation in cases of pre-fermentation, or filled into a separate container for distribution to start fermentation in cases of post-fermentation. After completion of the fermentation, sugar solutions may be added to these mixtures.

As a lactic acid bacteria starter inoculated to mixtures in the invention, one or more strains selected from L. bulgaricus, S. thermophilus, L. lactis, as well as lactic acid bacteria and natural yeasts generally used for the preparation of fermented milk can be used. In the present invention, a starter wherein a mixed starter of L. bulgaricus and S. thermophilus, which are standardized as yogurt starters in accordance with Codex standard, is used as a base can be preferably used. Using this yogurt starter as a base, other lactic acid bacteria such as L. gasseri and Bifidobacterium may be added with consideration given to fermentation temperature and fermentation conditions of the intended fermented milk.

With respect to the fermentation temperature, regardless of amount of milk fat, amount of SNF, and amount of addition of starter, a temperature lower than standard fermentation temperatures, for example 30° C.-46° C., may be adopted.

Even under the low fat condition of milk fat content between 0.1 wt %-2.0 wt %, fermentation can be performed at the above temperature range; however, the range of 30° C.-39° C. is preferred. In the case of low-fat content, the temperature of 32° C.-38° C. is especially preferred, and 34° C.-37° C. is more preferred, from the viewpoint of fermentation temperature and effects of improving milk-fat characteristic.

When fermented-milk mixtures have a standard milk fat content and high SNF (SNF of 11 wt % or more), fermentation can be performed at 30° C.-46° C.; 30° C.-40° C. is preferred, 32° C.-39° C. is especially preferred, and 34° C.-38° C. is furthermore preferred.

When the amount of a starter is reduced, fermentation can be performed at 30° C.-46° C.; when the amount of a starter is 50%-25% of the standard amount under the fermentation temperature of 38° C.-46° C., fermented milk with improved milk-fat characteristic can be obtained. This effect is particularly apparent under the low fat condition of 0.1 wt %-2.0 wt % milk fat.

In any case, it is preferred that the fermentation time is adjusted approximately between 3 h and 7 h, so that the entire fermentation process is completed within a day.

In the case of high-SNF fermented milk with reduced milk fat, when the fermentation temperature of the process according to the invention is too high, milk-fat characteristic tends to decrease compared with fermented milk with a standard milk fat content; in the case of high-SNF fermented milk without reduction of milk fat, the effect of improving milk-fat characteristic may gradually be reduced when the fermentation temperature exceeds 40° C. In the case of fermented milk with a standard SNF content with reduced milk fat, more preferable fermentation temperature is 38° C. or less. Similarly, regardless of SNF content, more preferable fermentation temperature is 39° C. or less when the milk fat content is not reduced.

With the process according to the invention, there are cases wherein fermentation time is significantly extended with a decrease in the fermentation temperature. At the fermentation temperature less than 30° C., the fermentation time increases due to a significant decrease in the growth rate of lactic acid bacteria compared to the case with the fermentation temperature of 30° C. or more. In the case of the process according to the invention, since the degree of a decrease in the growth rate of lactic acid bacteria accompanying a decrease in the fermentation temperature is smaller than that in standard processes, the fermentation temperature can be set at a lower temperature than the standard processes. Meanwhile, when the fermentation temperature is set to be 30° C. or more, the fermentation time can be a practical time for industrial mass production conditions. When the process according to the invention is used, the fermentation time is approximately 6 h under the fermentation temperature of 30° C., whereas it is 10-11 h when a standard process is used.

When fermentation time is set, a rough indicator of the end point of fermentation is generally obtained by measuring lactic-acid acidity. For example, in the case of fermented milk with 10 wt % SNF, a time point at which the lactic-acid acidity reaches 0.7% is determined to be the end point of fermentation (pH at this time point is 4.4-4.7). However, in the process according to the invention, an indicator other than the lactic-acid acidity is required due to buffering action associated with an increase in SNF. Therefore, instead of lactic-acid acidity, a pH value of the fermented-milk mixture is used as the indicator of the end point of fermentation; when the pH value becomes 4.4-4.7, it is determined to be the end point of fermentation.

As a method to reduce dissolved oxygen concentration in a mixture, any method may be applied including a method of inert gas replacement and a membrane separation process using deoxidized membrane. Important point here is to reduce the dissolved oxygen concentration to 5 ppm or less in the mixture. Among the above methods, because the inert gas replacement can be performed after addition of starters as mentioned above, its level of restriction on the process is small compared with the membrane separation process and others.

A method of inert gas replacement is explained below; replacement may be performed at any time point between the preparation of a material mixture and the start of fermentation after inoculation of a starter. However, since it is important that the mixture is maintained in a state of reduced dissolved oxygen concentration upon start of the fermentation, it is desirable that the inert gas replacement of the mixture is performed between immediately before and immediately after the inoculation of a starter.

According to previous examinations, as the dissolved oxygen concentration in a mixture upon start of fermentation was lowered, better results could be obtained. For example, when the temperature of a mixture is approximately 40° C., the dissolved oxygen concentration is 5 ppm or less, and preferably 3 ppm or less.

When the inert gas replacement is used to reduce dissolved oxygen concentration, nitrogen gas, argon gas, helium gas and others may be used as the inert gas; among them, nitrogen gas may be preferably used as the inert gas for general use in food products. As a method for replacing dissolved oxygen with inert gas, well-known methods may be used, including a method wherein these inert gases are directly bubbled into the mixture, a method to use a static mixer, or a method wherein the gas is introduced into a mixer together with the mixture for agitation.

When a membrane separation process is performed to reduce dissolved oxygen concentration, a hollow fiber membrane (MHF304KM and others, Mitsubishi Rayon Engineering Co., Ltd.) may be used as the deoxidized membrane. It may be used with reference to the instruction of the membrane; the membrane separation process can be performed by applying to the mixture prior to the addition of starters to reduce the dissolved oxygen concentration.

In the invention, both of reducing the fermentation temperature and reducing the amount of starter may be separately combined with a method to reduce dissolved oxygen concentration, or both conditions are combined first then may be combined with a method to reduce dissolved oxygen concentration. However, in order to obtain merits of respective conditions, it is preferable that in terms of process management, each of the conditions is respectively combined with a method to reduce dissolved oxygen concentration.

When the reduction of fermentation temperature or reduction of the amount of a starter to be added, each independently, is carried out in combination with the reduction of dissolved oxygen concentration in the fermented milk mix to 5 ppm or less as described in the foregoing, it was confirmed that fermented milk having improved milk-fat characteristic can be obtained by carrying out the fermentation at a temperature of from 30° C. to 39° C. regarding the lowering of the fermentation temperature to a lower level than usual, and regarding the reduction of the amount of a starter to be added to a level lower than usual, fermented milk having improved milk-fat characteristic can be obtained by carrying out the fermentation with setting an additive amount at 25% to 50% of the amount thereof to be usually used and at a temperature of from 38° C. to 46° C.

Next, when the condition of reducing the amount of starter is combined with a method to reduce dissolved oxygen concentration, the amount of a starter that is 50%-25% of the standard condition is used. The fermentation temperature under this condition may be, for example, 30° C.-46° C.; however, the use of the range of 38° C.-46° C. is preferred. Under high-temperature conditions, good milk-fat characteristic can be ensured by further reducing the amount of the starter. However, when the temperature exceeds 46° C., it becomes difficult to obtain the effect of improvement of milk-fat characteristic. Under this condition, a preferable temperature condition is 38° C.-45° C., and more preferably, it is 39° C.-43° C. The merit of adopting this method is to be able to ferment at a standard fermentation temperature; under the standard fermentation temperature, temperature control can be carried out easily as in the case of standard products, and in addition, risk such as contamination can be significantly reduced.

The standard amount of addition of starters, as a criterion for the amount of starters in the invention described above, is determined as the amount of a starter used for a fermented-milk mixture without reducing the dissolved oxygen concentration, that results in the lactic-acid acidity of 0.7% after fermentation at 43° C. for 3 h; this standard amount is defined as 100%.

In the present invention, both conditions of reducing the fermentation temperature and reducing the amount of starter are combined then can be possibly used under various conditions (for example, fermentation temperature is set at 34° C. and the amount of a starter is 60% of the standard amount). However, this is not recommended because combination becomes complex and merits of each condition may be diluted. For example, with the method of significantly reducing the amount of starters, it is possible to use a starter with an amount 50%-25% of the standard amount under the fermentation temperature from 38° C. to 46° C.; taking advantage of this merit, it is rational to use the method to reduce the amount of starters in cases when fermentation is performed at a standard temperature such as 40° C. or more, not under a low temperature.

In this regard, particularly in the critical region of the respective condition, the product yield obtained under the combination of the two factors (fermentation temperature and amount of starter) can be larger than that under only one factor; accordingly, it becomes inevitable to combine the two conditions. For example, when the fermentation temperature exceeds 39° C., there are cases wherein the temperature condition alone can hardly exhibit improvement of milk-fat characteristic. When the condition of reducing the amount of starter is combined in such cases, the product yield can be increased. Because of these merits, under the condition of reduced starter amount, the applicable fermentation temperature of 38° C. or more, which partially overlaps the condition of fermentation temperature alone, is preferred.

With the process according to the invention, fermentation temperature and the amount of starter are determined from the viewpoint of completing the fermentation within a certain period so that the entire fermentation process can be finished within one day. Accordingly, considering the long-term fermentation, there may be cases wherein different temperature ranges and different amounts of starter are used. Basically, it is evident that a technology in which dissolved oxygen concentration in a fermented-milk mixture is 5 ppm or less and fermentation temperature is decreased from a standard fermentation temperature is within the scope of the present invention.

In the case of the process of the invention, the fermentation temperature and additive amount of starter are set from the viewpoint of completing the fermentation within such a period of time that the whole fermentation process is finished in one day. Accordingly, when a long period fermentation is taken into consideration, it is considered that there may be a case of using different temperature range and amount of the starter to be added. However, it is obvious that such a technique is a technique which is within the category of the invention, with the proviso that it shows an effect of obtaining fermented milk having improved milk-fat characteristic by reducing dissolved oxygen concentration in the fermented milk mix to 5 ppm or less, and carrying out the fermentation by lowering the fermentation temperature from that in the usual fermentation condition, and/or sharply decreasing the amount of the starter to be added to the fermented milk mix from the usual additive amount, in producing a fermented milk in which the milk fat content is reduced to a level of from 0.1% to 2.0%, as the basic point of view.

In the present invention, under the condition that dissolved oxygen concentration was adjusted to be 5 ppm or less in a mixture for high-SNF fermented milk by means of various dissolved oxygen reduction methods, when the fermentation was performed at 30° C.-40° C. for fermented milk with a standard milk fat content, i.e., approximately 3 wt %, and at 30° C.-39° C. for fermented milk with a reduced milk fat content, then the overall flavor and mouth feel were clearly improved, although the hardness of the fermented milk did not reach the desired level in terms of flavor and mouth feel indicated in patent documents 2 and 3. Therefore, the improvement of flavor and mouth feel achieved by the invention was speculated to be caused by factors different from the formation of dense mouth feel obtained in patent documents 2 and 3.

In general, the SNF content of commercially available fermented milk is approximately 9 wt %-10 wt % regardless of soft type or hard type. When the SNF content exceeds 11 wt %, not that any one of the problems including 1) bad melt-in-mouth, 2) rough mouth feel, and 3) dry and crumbling mouth feel is exposed depending on the SNF content and others, but all of the three problems become obvious. At the point when the SNF content exceeds llwt %, most of panelists perceive deterioration of flavor and mouth feel. When the SNF content exceeds 12 wt %, all panelists clearly perceive deterioration of flavor and mouth feel. In contrast, deterioration of flavor due to a decrease in milk fat content is independent from the above three problems. In cases of low-fat fermented milk, an increase of SNF may cause some persons to feel an increase of “richness of taste (rich body),” so that the status of flavor deterioration is different from that for the cases wherein SNF content in the fermented milk having a standard milk fat content is increased. Namely, when SNF contents in the fermented milk having a standard milk fat content and in the low-fat fermented milk are increased, the status wherein deterioration of flavor is perceived differs. However, products with application of the inventive process show overall improvement of flavor, compared to products without application of the inventive process, indicating the effects of the process according to the invention in either case.

Even when the high SNF content used in the invention is 20 wt % or more, products with application of the inventive process is speculated to show some effects when merchantability is not taken into consideration, compared to products without application of the inventive process. The basis for this speculation is that the effects of the inventive process are clearly observed in the examination with SNF content of 18 wt %.

The range of milk fat content within the low-fat range to which the inventive process can be applied is from 0.1 wt % to 2.0 wt % Moreover, in the present invention, deterioration of flavor that accompanies high SNF content can be alleviated by reducing the dissolved oxygen concentration in the fermented-milk mixture, in addition to significantly reducing the starter amount.

### EXAMPLE

Hereinafter, the process according to the invention is explained in further detail on the basis of examples and test examples; however, the invention is not limited thereto.

### Example 1

### Production of Low-Fat Fermented Milk Using the Inventive Process (Fermentation Temperature: 38° C.)

A mixture combining 35.7 kg of cow milk, 6.8 kg of nonfat dry milk and 53.5 kg of water was prepared. The mixture composition was calculated with reference to Japanese Standard of Dietetic Information, ver. 5, using the following values: composition of cow milk: 8.8% SNF, 3.8% milk fat; composition of nonfat dry milk: 95.2% SNF, 1.0% milk fat. Next, the prepared mixture was sterilized by heating at 95° C. for 5 min, then cooled to 38° C., and inoculated with a 2.0% lactic acid bacteria starter (mixed culture of L. bulgaricus JCM 1002T and S. thermophilus ATCC 19258). Nitrogen gas was introduced and dispersed into this mixture through a pipe to adjust the dissolved oxygen concentration at 5 ppm or less. The resulting mixture was filled into a container, fermented at 38° C. until its lactic-acid acidity reached 0.7% (fermentation time: 3 h), then the fermentation was stopped by cooling to 10° C. or less to give the final product.

The composition of the final product in this case is 10.0% SNF and 1.5% milk fat.

At the same time, a fermented-milk mixture having a standard milk fat content (3.0%) was fermented at 43° C. for 3 h as usual, and the resulting fermented milk (control product: Q) was used as a comparative example for the comparison of milk-fat characteristic with the inventive product. As a result, the inventive product showed clearly stronger milk-fat characteristic than the control product.

### (Test Example 1, Refer to Table 1)

In each of the examples and test examples, the SNF contents of prepared products containing different milk-fat contents are fixed at 10.0%. Accordingly, the total solid decreases as the milk fat content decreases. For example, while the total solid of the fermented milk with 1.5% milk fat is 11.5%, that of the fermented milk with 0.5% milk fat is 10.5%. However, in these products, the solid equivalent to the decreased milk fat is not compensated by SNF. This is because an increase of SNF generates an effect to compensate rich body. Thus, the effect of the inventive process obtained in the examples can be evaluated to be clearly given by the inventive process.

The lactic-acid acidity was calculated by titration using 0.1N NaOH with phenolphthalein as an indicator.

### Test Example 1

### Comparison of Milk-Fat Characteristic Between Inventive Low-Fat Fermented Milk and Standard Product

The production process of Example 1 was applied to fermented-milk mixtures with various milk fat contents so that the fermented milk of the invention was prepared to have a milk fat content of 1.5%, 1.3%, 1.0% or 0.9%; the obtained inventive fermented milk was subjected to a sensory evaluation test by 8 or 9 specialized panelists using a paired comparison method, in comparison to simultaneously prepared fermented milk having a milk fat content of 3.0% produced by a standard fermentation process (conventional process). The evaluation criteria include three items of “smooth texture on the tongue,” “mildness of taste” and “richness of taste (rich body),” as well as “degree of sour taste” as a reference, totaling four items. In particular, results of the “richness of taste (rich body)” were evaluated with priority as sensory evaluation to represent milk-fat characteristic.

The “specialized panelist” is a specialist who can objectively evaluate or assess flavor, mouth feel etc. of a specific product in a sensory evaluation test.

The “a sensory evaluation test using a paired comparison method” is one of sensory evaluation tests which is generally used in the field of foods and beverages etc. and is the test in which one or more panelists evaluate superiority or inferiority of samples by judging which is superior between samples and control in each characteristics to be evaluated.

Results of the sensory evaluation test showed that in terms of “richness of taste (rich body)” and “smooth texture on the tongue,” the inventive fermented milk with 1.0% milk fat content was evaluated as almost equivalent to the standard product. The inventive fermented milks with 1.5% (Table 1) and 1.3% (Table 2) milk fat contents were evaluated as equivalent to the standard product in terms of “smooth texture on the tongue,” and as clearly “stronger” than the standard product in terms of “mildness of taste” and “richness of taste (rich body).” Furthermore, while sour taste tends to be sensed stronger when milk fat content is low in general, the inventive fermented milk showed weak sour taste although its milk fat content was low. Thus, we could confirm that the inventive fermented milk with a milk fat content of 1.0% or more is “delicious low-fat fermented milk” having similar or better milk-fat characteristic than the standard product (milk fat content of 30).

In Tables below, evaluation scores for P and Q represent evaluation scores calculated by an evaluation method of milk-fat characteristic, which will be described later (same evaluation is applied to Tables 3-5).

TABLE 1

| n = 9 | P is stronger | Q is stronger | No difference |
|---|---|---|---|
| Smooth texture on | 4 | 3 | 2 |
| the tongue | | | |
| Mildness of taste | 7 | 1 | 1 |
| Richness of taste | 5 | 1 | 3 |
| (rich body) | | | |
| Sour taste | 0 | 8 | 1 |

P: milk fat content: 1.5% (inventive process)
Q: milk fat content: 3.0% (conventional process)
P's evaluation score = 26.0, Q's evaluation score = 3.5
Overall evaluation of milk-fat characteristic: P can be evaluated as equivalent to or better than Q

TABLE 2

| n = 9 | P is stronger | Q is stronger | No difference |
|---|---|---|---|
| Smooth texture on | 4 | 3 | 2 |
| the tongue | | | |
| Mildness of taste | 6 | 1 | 2 |
| Richness of taste | 6 | 1 | 2 |
| (rich body) | | | |
| Sour taste | 2 | 5 | 2 |

P: milk fat content: 1.3% (inventive process)
Q: milk fat content: 3.0% (conventional process)
P's evaluation score = 23.0, Q's evaluation score = 4.5
Overall evaluation of milk-fat characteristic: P can be evaluated as equivalent to or better than Q

### Example 2

### Production of Low-Fat Fermented Milk Using the Inventive Process (Starter Reduction Process)

A production process similar to Example 1 was adopted except that the amount of the lactic acid bacteria starter was 0.8% (40% of the standard amount), and the fermentation temperature was 43° C. Flavor and mouth feel of the obtained product were compared with those of the standard product with 3.0% milk fat (fermented milk by the conventional process); as shown in Table 3, it was confirmed that the inventive product showed milk-fat characteristic similar to that of the standard product with 3.0% milk fat.

TABLE 3

| n = 8 | P is stronger | Q is stronger | No difference |
|---|---|---|---|
| Smooth texture on | 2 | 5 | 1 |
| the tongue | | | |
| Mildness of taste | 3 | 4 | 1 |
| Richness of taste | 2 | 3 | 3 |
| (rich body) | | | |
| Sour taste | 0 | 7 | 1 |

P: milk fat content: 1.5% (starter reduction process according to the invention)
Q: milk fat content: 3.0% (conventional process)
P's evaluation score = 14.5, Q's evaluation score = 12.0
Overall evaluation of milk-fat characteristic: P can be evaluated as equivalent to or better than Q

### Test Example 2

### Sensory Evaluation Test of Standard Low-Fat Fermented Milk (Milk Fat: 1.5%) and Nonfat Inventive Product (Milk Fat: 0.5%, 0.1%)

When the milk fat content of the inventive fermented milk is 1% or less, evaluation results of a sensory evaluation test relative to fermented milk with a standard milk fat content (3%) may be one-sided results; therefore, fermented milk with a reduced milk fat content of 1.5% produced by standard fermentation (control product: Q) was compared with inventive fermented milk with a milk fat content of 0.5% or 0.1% by a sensory evaluation test similar to that in Test example 1. Tables 4 and 5 show results obtained. In terms of “richness of taste (rich body),” the inventive fermented milk with 0.5% milk fat content was evaluated to be “stronger” than the standard fermented milk with 1.5% milk fat content (Table 4). In addition, in terms of “richness of taste (rich body),” the inventive fermented milk with 0.1% milk fat content was evaluated to be “similar” to the control product (Table 5). Meanwhile, in terms of “smooth texture on the tongue,” both inventive products were inferior to the control product (Q); these results indicated that in terms of overall milk-fat characteristic considering all evaluation items, the inventive products require examination of addition of milk fat alternatives. However, it was confirmed that the inventive fermented milk shows apparent improvement of milk-fat characteristic even in the region wherein “nonfat” label is possible. Furthermore, the use of the inventive process enables low-fat fermented milk with 0.5% or 0.1% milk fat content to have milk-fat characteristic equivalent to or better than that of fermented milk produced by the standard process, having 1.5% or 1.1% milk fat content, respectively, i.e., at least 1 wt % higher milk fat content.

TABLE 4

| n = 8 | P is stronger | Q is stronger | No difference |
|---|---|---|---|
| Smooth texture on | 0 | 8 | 0 |
| the tongue | | | |
| Mildness of taste | 2 | 5 | 1 |
| Richness of taste | 5 | 1 | 2 |
| (rich body) | | | |
| Sour taste | 2 | 5 | 1 |

P: milk fat content: 0.5% (inventive process)
Q: milk fat content: 1.5% (conventional process)
P's evaluation score = 14.0, Q's evaluation score = 10.0
Overall evaluation of milk-fat characteristic: P can be evaluated as equivalent to or better than Q

TABLE 5

| n = 8 | P is stronqer | Q is stronger | No difference |
|---|---|---|---|
| Smooth texture on | 3 | 3 | 2 |
| the tongue | | | |
| Mildness of taste | 4 | 3 | 1 |
| Richness of taste | 3 | 3 | 2 |
| (rich body) | | | |
| Sour taste | 0 | 7 | 1 |

P: milk fat content: 0.1% (inventive process)
Q: milk fat content: 1.5% (conventional process)
P's evaluation score = 16.5, Q's evaluation score = 8.5
Overall evaluation of milk-fat characteristic: P can be evaluated as equivalent to or better than Q

### Test Example 3

### Examination of the Relationship Between Fermentation Temperature and Milk-Fat Characteristic, Etc.

Effects of the fermentation temperature on milk-fat characteristic and product hardness when the milk fat content was 1.5% were investigated. Production of fermented milk was performed in accordance with the production process of Example 1 except that the fermentation temperature and fermentation time were changed, and the obtained inventive products were compared with fermented milk with 3% milk fat produced by standard fermentation. In this examination, the range of the fermentation temperature was set so that fermentation was completed within 7 h. In addition, as examples of applicable products of the invention, we evaluated the applicability of the invention to pre-fermentation type (mainly dessert type) and post-fermentation type (mainly hard type) fermented milks using the hardness of the fermented milk as the indicator. Table 6 shows results.

TABLE 6

| Fermentation | Evaluation of | |
|---|---|---|
| temperature (° C.) | flavor | Optimal product type |
| 40 | Δ | — |
| 39 | ◯ | Post-fermentation type |
| 38 | ⊚ | Post-fermentation type |
| 37 | ⊚ | Post-fermentation type |
| 36 | ⊚ | Post-fermentation type |
| 35 | ⊚ | Post-fermentation type |
| 34 | ⊚ | Post-fermentation type |
| 33 | ⊚ | Pre-fermentation type |
| 32 | ⊚ | Pre-fermentation type |
| 31 | ⊚ | Pre-fermentation type |
| 30 | ⊚ | Pre-fermentation type |

Evaluated products: 1.5% milk fat
Evaluation:
⊚: The inventive product shows better milk-fat characteristic than the standard product (conventional process, 3% milk fat).
◯: The inventive product shows milk-fat characteristic equivalent to that of the standard product.
Δ: The inventive product shows rich body, but is inferior to the standard product in terms of milk-fat characteristic.
Note 1:
The fermentation temperature less than 30° C. was not evaluated because the fermentation time exceeds 7 h.
Note 2:
Product type is mainly evaluated by the hardness (post-fermentation: relatively hard, pre-fermentation: relatively soft)

### Test Example 4

### Examination of the Value of Milk Fat Content at which Deterioration of Flavor is Perceived

In order to evaluate applicable product range of the present invention, sensory evaluation tests of standard fermented milk with different milk fat contents were performed. Table 7 shows sensory test results of the standard fermented milk with the standard milk fat content (3.0%) and the reduced milk fat content (2.0%). The results demonstrate that when the milk fat content decreases to 2.0%, evaluation of the fermented milk with 2.0% milk fat content is downgraded in terms of all three evaluation items of “smooth texture on the tongue,” “mildness of taste” and “richness of taste (rich body),” although there were some disagreements in the evaluation of “richness of taste (rich body).” Thus, from the comprehensive viewpoint, since decreases in milk-fat characteristic are clearly perceived as the milk fat content decreases to 2.0%, the applicable product range of the invention is set to be fermented milk with the milk fat content of 2.0% or less.

TABLE 7

| n = 8 | Q1 is stronger | Q2 is stronger | No difference |
|---|---|---|---|
| Smooth texture on | 8 | 0 | 0 |
| the tongue | | | |
| Mildness of taste | 8 | 0 | 0 |
| Richness of taste | 4 | 2 | 2 |
| (rich body) | | | |
| Sour taste | 2 | 4 | 2 |

Q1: milk fat content: 3.0% (conventional process)
Q2: milk fat content: 2.0% (conventional process)

According to the Japanese Standard of Dietetic Information, “low-fat” food must be those containing 3 g or less fat per 100 g of the food (milk fat content of 3% or less). In cases of fermented milk however, because standard fermented milk has a fat content of approximately 3%, enhanced label of “low-fat” can be used for products having a fat content of 1.5% or less. The enhanced label of “nonfat” can be used for products having a fat content of 0.5% or less. While the effects of the present invention are prominent in these “low-fat” to “nonfat” regions, the effects can also be clearly confirmed in products with a reduced milk fat content of approximately 2.0%; therefore, the subjects of the invention are not limited to “low-fat” and “nonfat” fermented milk, but the present invention can be applied to products with a fat content of 2.0% or less as fermented milk with a less-than-usual milk fat content. Namely, because the sensory evaluation results showed that when the milk fat content in the fermented milk produced by the conventional process was decreased to 2.0% from the standard value of approximately 3%, an apparent decrease in the milk-fat characteristic was perceived (Table 7), it has become clear that the fermented milk to which the inventive process can be applied in order to improve its milk-fat characteristic is the fermented milk having a milk fat content of 2% or less.

### Example 3

### Production of High-SNF Low-Fat Fermented Milk Using the Process According to the Invention

A mixture combining 36.7 kg of cow milk, 10.1 kg of nonfat dry milk and 51.2 kg of water was prepared. SNF and milk fat contents in the mixture composition were calculated with reference to Japanese Standard of Dietetic Information, ver. 5, using the following values: composition of cow milk: 8.8% SNF, 3.8% milk fat; and composition of nonfat dry milk: 95.2% SNF, 1.0% milk fat. Next, the prepared mixture was sterilized by heating at 95° C. for 5 min, then cooled to 38° C., and inoculated with a 2.0% lactic acid bacteria starter (mixed culture of L. bulgaricus JCM 1002T and S. thermophilus ATCC 19258). Nitrogen gas was introduced and dispersed into this mixture through a pipe to adjust the dissolved oxygen concentration at 5 ppm or less. The resulting mixture was filled into a container, fermented at 38° C. until its pH reached 4.6 (fermentation time: 3 h), then the fermentation was stopped by cooling to 10° C. or less to give the final product. The composition of the final product in this case is 13.0% SNF and 1.5% milk fat.

### Test Example 5

### Comparison of Flavor Between Inventive High-SNF Low-Fat Fermented Milk and Standard High-SNF Low-Fat Fermented Milk

The inventive fermented milk was prepared in accordance with the production process of Example 3, and it was compared with the fermented milk produced from a simultaneously-prepared fermented-milk mixture with the same composition as in Example 3 and fermented using a standard fermentation process, by means of a sensory evaluation test by 5 specialized panelists using a paired comparison method. Evaluation criteria were “melt-in-mouth” and “smoothness of mouth feel.” As a result, in comparison to the fermented milk by the standard process (Q), the fermented milk of the invention (P) was evaluated as “better” by all the 5 specialized panelists for both items (Table 8). Thus, the inventive product was confirmed to be “high-SNF low-fat fermented milk with good flavor” in which demerits of the conventional high-SNF low-fat fermented milk have been improved.

TABLE 8

| n = 5 | P is better | Q is better | No difference |
|---|---|---|---|
| Level of | 5 | 0 | 0 |
| melt-in-mouth | | | |
| Smoothness of texture | 5 | 0 | 0 |

P: Product by the inventive process
Q: Product by the conventional process

### Example 4

### Production of Standard-Fat-Content Fermented Milk Using the Process According to the Invention

A mixture combining 77.2 kg of cow milk, 6.3 kg of nonfat dry milk and 14.5 kg of water was prepared. The mixture composition was calculated with reference to Japanese Standard of Dietetic Information, ver. 5, using the following values: composition of cow milk: 8.8% SNF, 3.8% milk fat; composition of nonfat dry milk: 95.2% SNF, 1.0% milk fat. Next, the prepared mixture was sterilized by heating at 95° C. for 5 min, then cooled to 38° C., and inoculated with a 2.0% lactic acid bacteria starter (mixed culture of L. bulgaricus JCM 1002T and S. thermophilus ATCC 19258). Nitrogen gas was introduced and dispersed into this mixture through a pipe to adjust the dissolved oxygen concentration at 5 ppm or less. The resulting mixture was filled into a container, fermented at 38° C. until its pH reached 4.6 (fermentation time: 3 h), then the fermentation was stopped by cooling to 10° C. or less to give the final product. The composition of the final product in this case is 13.0% SNF and 3.0% milk fat.

### Test Example 6

### Comparison of Flavor Between Inventive High-SNF Standard-Fat-Content Fermented Milk and Standard High-SNF Standard-Fat-Content Fermented Milk

Fermented milk of the invention was prepared in accordance with the production process of Example 4, and it was compared with the fermented milk produced from a simultaneously-prepared fermented-milk mixture with the same composition as in Example 4 and fermented using a standard fermentation process, by means of a sensory evaluation test by 5 specialized panelists using a paired comparison method. Evaluation criterion was “smoothness of mouth feel.” As a result, in comparison to the product of the standard process, the inventive fermented milk was evaluated as “better” by all the 5 specialized panelists for “smoothness of mouth feel.” Thus, the product of the invention was confirmed to be “high-SNF fermented milk with good flavor” in which demerits of the conventional high-SNF fermented milk have been improved.

### Test Example 7

### Examination of the Relationship Between SNF Content and Sensory Evaluation Results

Under the condition of the fat content fixed at 4.5%, the flavor was compared between inventive high-SNF high-fat fermented milk and conventional high-SNF high-fat fermented milk at three different SNF contents. At the SNF contents of 18, 16 and 13%, the flavor was compared between two kinds of fermented milk prepared by the inventive process and by the standard process (standard product). Table 9 shows results of the 5-grade sensory evaluation of “mildness” and “sour taste” by 5 specialized panelists. Compared with the fermented milk prepared by the standard process, the fermented milk prepared by the inventive process showed superior results in terms of both “mildness of mouth feel” and “not sensing very sour taste.” In particular, in the case of 18% SNF content which was the highest SNF content in this examination, the inventive product was clearly judged to be superior in flavor and mouth feel compared to the standard product, giving an expectation that even at higher SNF content ranges, the fermented milk produced by the inventive process may exhibit superior results in terms of deliciousness compared to standard products.

TABLE 9

| | | Mild mouth | |
|---|---|---|---|
| SNF(%) | Production process | feel | Sour taste |
| 18.0 | Inventive process | ⊚ | ⊚ |
| | Conventional process | XX | ◯ |
| 16.0 | Inventive process | ◯ | ⊚ |
| | Conventional process | XX | ◯ |
| 13.0 | Inventive process | ⊚ | ◯ |
| | Conventional process | X | XX |

Evaluated by 5 panelists

| | | |
|---|---|---|
| Grade | Mild texture | Sour taste |
| ⊚ | Highly mild | Very weakly sour |
| ◯ | Mild | Weakly sour |
| Δ | Relatively mild | Sour |
| X | Weakly mild | Strongly sour |
| XX | Not mild | Very strongly sour |

As described above, the process according to the invention can effectively suppress decreases of flavor and mouth feel of fermented milk caused by its high SNF and/or low fat content, by means of modifications in the production process without using improving agents of flavor and mouth feel, so that it can provide novel and delicious low-fat fermented milk, high-SNF fermented milk or high-SNF low-fat fermented milk having an unique and natural composition to the market; thus the process of the invention has remarkable effects.

### (Evaluation Method of Milk-Fat Characteristic)

In the comparison of fermented milk P and fermented milk Q, evaluation may be carried out by comparing evaluation scores calculated as follows: a sensory evaluation test is performed by specialized panelists using a paired comparison method to evaluate items of “smooth texture on the tongue,” “mildness of taste,” “richness of taste (rich body)” and “degree of sour taste;” then, based on the number A-L of specialized panelists shown in Table 10, evaluation scores for P and Q are calculated using the calculation formula below. The product with higher score may be evaluated to have stronger milk-fat characteristic.

TABLE 10

| | P is stronger | Q is stronger | No difference |
|---|---|---|---|
| Smooth texture on | A | E | I |
| the tongue | | | |
| Mildness of taste | B | F | J |
| Richness of taste | C | G | K |
| (rich body) | | | |
| Degree of sour taste | D | H | L |

(Calculation formula)
P's evaluation space = (A + I) × 0.5 + (B + J) × 1.0 + (C + K) × 2.0 − (D + L) × 1.0
Q's evaluation space = (E + I) × 0.5 + (F + J) × 1.0 + (G + K) × 2.0 − (H + L) × 1.0

Has been described with reference to specific embodiments the invention in detail, it can be that various changes and modifications without departing from the spirit and scope of the present invention will be apparent to those of ordinary skill in the art. This application is based Japanese Patent Application (Application No. 2005-300646) filed Oct. 14, 2005, the contents of which are incorporated herein by reference.

In addition, all references cited herein are incorporated in their entirety.

1-7. (canceled)

8. A process for producing fermented milk having a milk fat content from 0.1% by weight to 1.0% by weight and having milk-fat characteristic that is equivalent to or greater than that of a fermented milk having about 1.5% milk fat content produced from a fermented milk mix with a milk fat content of 1.5% fermented at 43° C. for 3 hours without addition of a milk-fat alternative or a milk-flavor providing agent, said process comprising:
reducing a dissolved oxygen concentration in a fermented milk mix with milk fat content from 0.1% by weight to 1.0% by weight to 5 ppm or less at the time of the start of fermentation; and
carrying out the fermentation at a fermentation temperature of from 30° C. to 39° C.

9. A process for producing fermented milk having a milk fat content from 1.0% by weight to 2.0% by weight and having milk-fat characteristic that is equivalent to or greater than that of a fermented milk having about 3% milk fat content produced from a fermented milk mix with a milk fat content of 3% fermented at 43° C. for 3 hours without addition of a milk-fat alternative or a milk-flavor providing agent, said process comprising:
reducing a dissolved oxygen concentration in a fermented milk mix with milk fat content from 1.0% by weight to 2.0% by weight to 5 ppm or less at the time of the start of fermentation; and
carrying out the fermentation at a fermentation temperature of from 30° C. to 39° C.

10. A process for producing fermented milk having a milk fat content from 0.1% by weight to 1.0% by weight and having milk-fat characteristic that is equivalent to or greater than that of a fermented milk having about 1.5% milk fat content produced from a fermented milk mix with a milk fat content of 1.5% fermented at 43° C. for 3 hours without addition of a milk-fat alternative or a milk-flavor providing agent, said process comprising:
reducing a dissolved oxygen concentration in a fermented milk mix with milk fat content from 0.1% by weight to 1.0% by weight to 5 ppm or less at the time of the start of fermentation;
setting an amount of a starter to be added to the fermented milk mix at from 0.5% by weight to 1.0% by weight with respect to the total amount of the fermented milk mix; and
carrying out the fermentation at a fermentation temperature of from 38° C. to 46° C.

11. A process for producing fermented milk having a milk fat content from 1.0% by weight to 2.0% by weight and having milk-fat characteristic that is equivalent to or greater than that of a fermented milk having about 3% milk fat content produced from a fermented milk mix with a milk fat content of 3% fermented at 43° C. for 3 hours without addition of a milk-fat alternative or a milk-flavor providing agent, said process comprising:
reducing a dissolved oxygen concentration in a fermented milk mix with milk fat content from 0.1% by weight to 1.0% by weight to 5 ppm or less at the time of the start of fermentation;
setting an amount of a starter to be added to the fermented milk mix at from 0.5% by weight to 1.0% by weight with respect to the total amount of the fermented milk mix; and
carrying out the fermentation at a fermentation temperature of from 38° C. to 46° C.

12. The process for producing fermented milk according to any one of claims 8 to 11, wherein the fermentation is carried out within such a period of time that the all fermentation steps are completed in one day.

13. The process for producing fermented milk according to any one of claims 8 to 11, wherein the fermentation time is from 3 to 7 hours.

14. A fermented milk which is obtainable by the process according to any one of claims 8 to 11.

15. A process for improving milk-fat characteristic of fermented milk having a milk fat content from 0.1% by weight to 1.0% by weight, said process comprising:
reducing a dissolved oxygen concentration in a fermented milk mix with milk fat content from 0.1% by weight to 1.0% by weight to 5 ppm or less at the time of the start of fermentation; and
carrying out the fermentation at a fermentation temperature of from 30° C. to 39° C.,
wherein the milk-fat characteristic is improved to be equivalent to or greater than that of a fermented milk having about 1.5% milk fat content produced from a fermented milk mix with a milk fat content of 1.5% fermented at 43° C. for 3 hours without addition of a milk-fat alternative or a milk-flavor providing agent.

16. A process for improving milk-fat characteristic of fermented milk having a milk fat content from 1.0% by weight to 2.0% by weight, said process comprising:
reducing a dissolved oxygen concentration in a fermented milk mix with milk fat content from 1.0% by weight to 2.0% by weight to 5 ppm or less at the time of the start of fermentation; and
carrying out the fermentation at a fermentation temperature of from 30° C. to 39° C.,
wherein the milk-fat characteristic is improved to be equivalent to or greater than that of a fermented milk having about 3% milk fat content produced from a fermented milk mix with a milk fat content of 3% fermented at 43° C. for 3 hours without addition of a milk-fat alternative or a milk-flavor providing agent.

17. A process for improving milk-fat characteristic of fermented milk having a milk fat content from 0.1% by weight to 1.0% by weight, said process comprising:
reducing a dissolved oxygen concentration in a fermented milk mix with milk fat content from 0.1% by weight to 1.0% by weight to 5 ppm or less at the time of the start of fermentation;
setting an amount of a starter to be added to the fermented milk mix at from 0.5% by weight to 1.0% by weight with respect to the total amount of the fermented milk mix; and
carrying out the fermentation at a fermentation temperature of from 38° C. to 46° C.,
wherein the milk-fat characteristic is improved to be equivalent to or greater than that of a fermented milk having about 1.5% milk fat content produced from a fermented milk mix with a milk fat content of 1.5% fermented at 43° C. for 3 hours without addition of a milk-fat alternative or a milk-flavor providing agent.

18. A process for improving milk-fat characteristic of fermented milk having a milk fat content from 1.0% by weight to 2.0% by weight, said process comprising:
reducing a dissolved oxygen concentration in a fermented milk mix with milk fat content from 1.0% by weight to 2.0% by weight to 5 ppm or less at the time of the start of fermentation;
setting an amount of a starter to be added to the fermented milk mix at from 0.5% by weight to 1.0% by weight with respect to the total amount of the fermented milk mix; and
carrying out the fermentation at a fermentation temperature of from 38° C. to 46° C.,
wherein the milk-fat characteristic is improved to be equivalent to or greater than that of a fermented milk having about 3% milk fat content produced from a fermented milk mix with a milk fat content of 3% fermented at 43° C. for 3 hours without addition of a milk-fat alternative or a milk-flavor providing agent.
